(19) United States
(12) Patent Application Publication
(10) Pub. No.: US 2026/0037608 A1
(43) Pub. Date: Feb. 5, 2026

(54) USER INTERFACE FOR IMPROVING USER SECURITY IN VIRTUAL REALITY ENVIRONMENTS

(71) Applicant: Wells Fargo Bank, N.A., San Francisco, CA (US)

(72) Inventors: David P. Bendert, Charlotte, NC (US); Jason Franklin Frye, Monroe, NC (US); Mary Katherine Henley Hoskins, Charlotte, NC (US); Scott D. Hutula, Concord, NC (US); Steven A. Jolley, Chester, SC (US); Dharmendra V. Makwana, Matthews, NC (US); Benjamin Charles Norris, Rock Hill, SC (US); Ravi Kumar Sarvepalli, Matthews, NC (US); Matthew O. Spain, Charlotte, NC (US)

(21) Appl. No.: 18/793,169

(22) Filed: Aug. 2, 2024

(51) Int. Cl. G06F 21/36

(52) U.S. Cl. CPC G06F 21/36

(57) ABSTRACT

Various examples are directed to authenticating a user to a virtual reality (VR) host computing system. A VR appliance may access credential data for the user. The VR appliance may access an indication that the credential data fails to meet a credential data standard. The VR appliance may authenticating the user to the VR host computing system using the credential data. The VR appliance may server, to the user, a VR user interface. Responsive to the indication that the credential data fails to meet the credential data standard, the VR appliance may modify the VR user interface to include a first user interface element and a second user interface element. The first user interface element may describe a deficiency of the credential data. The second user interface element may comprise at least one animated element illustrating a potential consequence of a breach of the credential data for the user.

### BACKGROUND

Virtual reality (VR), augmented reality (AR), and extended reality (ER) technology provide users with virtual environments where users can interact with other users, purchase goods and services from merchants, and engage in gaming. In a virtual environment, users, merchants, and other parties may authenticate themselves to other parties participating in the virtual environment.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment including a VR host computing system.

FIG. 2 is a diagram showing another example of the environment of FIG. 1 including additional details.

FIG. 3 is a flowchart showing one example of a process flow that may be executed in the environment of FIG. 1 to authenticate a user.

FIG. 4 is a flowchart showing one example of a process flow that may be executed by the VR host computing system of FIG. 1 to determine to authenticate a user in an augmented or extended reality environment.

FIG. 5 is a flowchart showing another example of a process flow that may be executed by the VR host computing system of FIG. 1 to determine to authenticate a user in an augmented or extended reality environment.

FIG. 6 is a diagram showing one example of augmented user interface elements in a VR user interface.

FIG. 7 is a diagram showing one example of augmented user interface elements in a VR user interface, including a user interface element with an animated element illustrating a potential consequence of a breach of the user's credential data.

FIG. 8 is a diagram showing one example of augmented user interface elements in a VR user interface, including a user interface element with an animated element illustrating a potential consequence of a breach of the user's credential data.

FIG. 9 is a block diagram showing one example of a software architecture for a computing device.

FIG. 10 is a block diagram illustrating a computing device hardware architecture, within which a set or sequence of instructions can be executed to cause a machine to perform examples of any one of the methodologies discussed herein.

### DETAILED DESCRIPTION

Virtual environments in which users participate using avatars may be used for various different types of commercial and social interactions that have historically been performed in person. For example, a user may visit a site in the virtual environment associated with a merchant. When the user visits the merchant's site, the user's avatar may be visible to one or more third parties associated with the merchant and one or more third-party avatars associated with the merchant may be visible to the user. The user may interact with one or more of the third-party avatars to purchase goods and/or services.

The user may have business interactions with one or more other parties in the virtual environment. For example, the user may purchase goods or services from other parties to the virtual environment. In some examples, a user may receive professional services in the virtual environment such as financial services, legal services, and/or the like.

To engage in a business interaction with another party to a virtual environment, a user may visit a site in the virtual environment that is associated with the other party (e.g., merchant, financial service provider, and/or the like). The site in the virtual environment may be a virtual site and/or a physical location that is augmented by one or more augmented interface elements, as described herein. A physical location that is augmented by one or more augmented interface elements may be referred to as an augmented location.

The user may authenticate, for example, through a VR appliance that provides a VR user interface to the user and/or through a user computing device. The user may directly or indirectly provide credential data to the VR appliance. The VR appliance may provide the credential data to a VR host computing system, which may utilize the user's credential data to authenticate the user. For example, the VR host computing system may compare the user's credential data to stored credential data for that user. If the provided credential data matches the stored credential data, the user is authenticated. In this way, party conducting business with the user may have a level of confidence that the user is who the user claims to be.

It will be appreciated that the cost of a breach of a user's credential data can be significant. For example, a malign actor who obtains access to a user's credential data may impersonate the user in the virtual environment including, to potential business partners. Consider an example in which a malign actor utilizes stolen user credentials to impersonate the user to a financial services provider. Such a malign actor may obtain access to the user's financial accounts.

In various VR environments, authentication techniques are often carried over from non-VR environments, which can lead to additional vulnerability. For example, the user may directly provide credential data, such as a user name and password, using a virtual keyboard or other input device that is provided in the VR environment. In some examples, the virtual keyboard and other input devices available in a virtual environment may be more difficult to use than physical keyboards and similar input devices traditionally associated with the use of computing systems outside of virtual environments. Users may be inclined to utilize credential data that is easy to enter such as, for example, passwords that are common to other accounts of the user, passwords that are short, predictable, or that lack diversity of character types. Although these user tendencies may exist outside of virtual environments, the difficulties of inputting credential data using input devices available in the virtual environment may accentuate these difficulties.

Better and more secure credential data may be available. For example, a user may select a password that includes more characters, is less predictable, and/or includes a diversity also, in some examples, the virtual environment (e.g., a VR host computing system thereof) may offer biometric and other more secure forms of credential data.

In some examples, however, it is the user's decision to select and use higher quality credential data. Some VR host computing systems may permit users to use credential data that meets a minimum security standards but may not require users to use more secure credential data. For example, the viability of VR host computing systems may depend on user participation. User participation may be compromised if more stringent credential data security requirements motivate users eschew virtual environments for more traditional computing systems. These issues may be made more acute by the limitations of a VR environment, especially with respect to data input. Users may be even less motivated to use more secure credential data because of the inherent difficulties of providing longer and more complicated credential data in a virtual environment using a virtual keyboard or other similar input device.

These and other challenges may be addressed with the example virtual reality authentication described herein. For example, when a user authenticates to a VR host computing system, the VR host computing system may access credential data for the user. The VR host computing system may be programmed to compare the credential data to at least one credential data standard. The credential data standard may indicate a level of security associated with the credential data. If the credential data fails to meet the credential data standard, the VR host computing system may display a VR user interface to the user, where the VR user interface comprises user interface elements indicating to the user that the user's credential data could be made more secure. The VR user interface may be provided, for example, to a VR appliance such that the user experiences the VR user interface in the virtual environment.

In some examples, a first user interface element provided with the VR user interface may include a description of a deficiency in the user's credential data (e.g. the reason or reasons that the user's credential data failed to meet the credential data standard). The first user interface element may include one or more alphanumeric characters that are displayed to the user via the VR appliance. The alphanumeric characters may spell out text describing the deficiency of the user's credential data.

The second user interface element may comprise an animated feature that illustrates a potential consequence of a breach of the user's credential data. In some examples, the second user interface element may comprise an alphanumeric representation of an account balance. The alphanumeric representation of the account balance may be animated such that the account balance falls or becomes less. In some examples, the second user interface element may comprise a representation of a humanoid avatar or other indication of an individual absconding from the user's view with a representation of money or other value that could be taken from the user if the user's credentials were breached. In some examples, the VR user interface may also comprise a link or other UI element selectable by the user to permit the user to modify the existing credential data to transition to a more secure credential data.

In this way, users utilizing less than optimally secure credential data may be made aware of the potential risks of continuing with the user's existing credential data and may be motivated to upgrade to more secure credential data. Accordingly, the security of the virtual environment may be increased, reducing inefficiencies in the virtual reality environment and associated computing systems due to the compromising of user credential data.

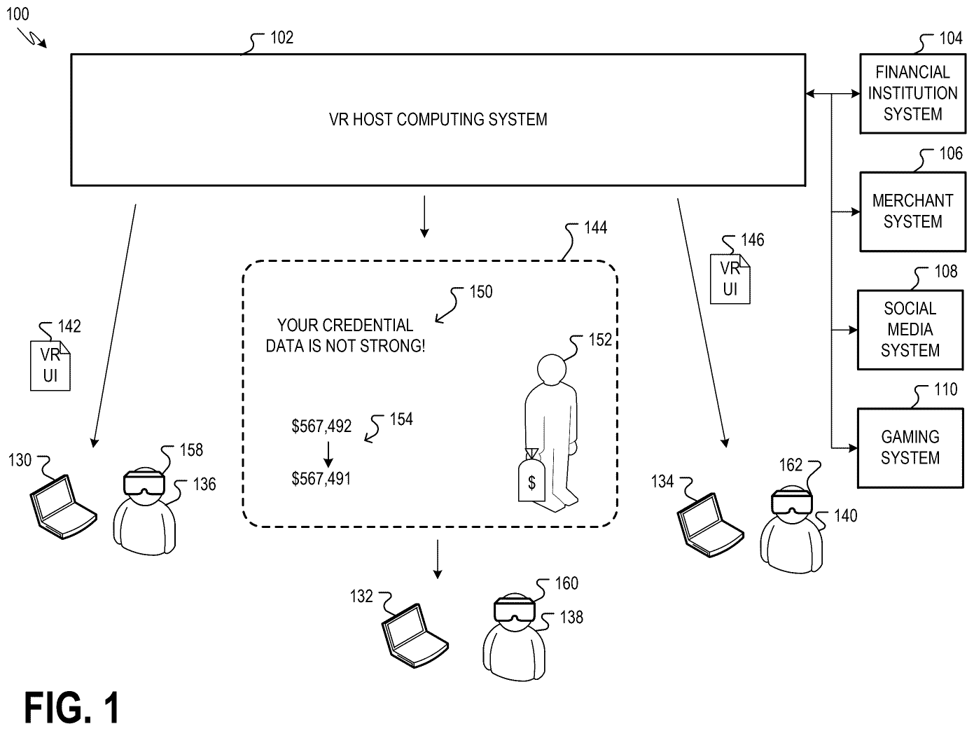

FIG. 1 is a diagram showing one example of an environment 100 including a VR host computing system 102. The VR host computing system 102 provides VR user interfaces 142, 144, 146 to users 136, 138, 140. The VR user interfaces 142, 144, 146 may be served to the users 136, 138, 140 via user computing devices 130, 132, 134 and/or VR appliances 158, 160, 162. The VR user interfaces 142, 144, 146 provide access to a VR environment that may include various different sites. For example, various other systems may be in communication with the VR host computing system 102 in order to provide sites in the VR environment. In some examples, a VR appliance 158, 160, 162 may comprise an augmented reality display. An augmented reality display is a display through which the user 136, 138, 140 may view the user's in the environment. The augmented reality display may display augmented reality elements such that the augmented reality elements appear, to the user 136, 13A, 140, to be present in and/or superimposed over physical elements in the user's environment.

A financial institution system 104 may be associated with a financial institution. The financial institution system 104 may provide sites in the virtual environment that can be visited by users 136, 138, 140. For example, sites provided by financial institution system 104 may facilitate the providing of financial services to users 136, 138, 140.

A merchant system 106 may be associated with a merchant. Merchant system 106 may provide sites in the virtual environment that facilitate the purchase of goods and/or services by the users 136, 138, 140.

Social media system 108 may be associated with a social media platform providers. The social media system 108 may provide sites in the virtual environment that facilitate participation by the users 136, 138, 140 in respective social media platforms.

A gaming system 110 may be associated with game providers. The gaming system 110 may provide sites in the virtual environment that may be visited by the users 136, 138, 140. Users 136, 138, 140 may visit gaming sites provided by the gaming system 110 to participate in various different games such as, for example, video games, gaming, and/or the like. Although one respective financial institution system 104, merchant system 106, social media system 108, and gaming system 110 are shown, it will be appreciated that multiple examples of each type of system may be included in the environment 100. It will also be appreciated that other systems associated with other parties in the virtual environment may be included.

In some examples, the VR host computing system 102 may be implemented by the same enterprise implementing one or more of the systems 104, 106, 108, 110. For example, a financial institution implementing the financial institution system 104 may also implement the VR host computing system 102 to provide a VR environment to the users 136, 138, 140 allowing the users 136, 138, 140 to access sites and augmented reality locations associated with the financial institution. Similarly, in some examples, a merchant enterprise implementing the merchant system 106 may also implement the VR host computing system 102, allowing the users 136, 138, 140 to access sites and virtual reality locations associated with the merchant enterprise. In some examples, the VR host computing system 102 may facilitate authentication of the users 136, 138, 140 to the individual systems 104, 106, 108, 110. For example, a user 136, 138, 140 may have separate accounts and/or credential data associated with the financial institution system 104, the merchant system 106, the social media system 108, and/or the gaming system 110, respectively.

The VR host computing system 102 may serve the VR user interfaces 142, 144, 146 to the users 136, 138, 140 via the respective user computing devices 130, 132, 134 and/or VR appliances 158, 160, 162. The user computing devices 130, 132, 134 may be any suitable computing device or devices such as, for example, smart phones, tablet computers, laptop computers, smart watches, and/or the like. User computing devices 130, 132, 134 comprise input/output (I/O) devices for providing the VR user interfaces 142, 144, 146 to the users 136, 138, 140. For example, user computing devices 130, 132, 134 comprise a display for showing all or part of the VR user interfaces 142, 144, 146 to users 136, 138, 140.

In some examples, all or part of the VR user interfaces 142, 144, 146 may be provided via VR appliances 158, 160, 162. VR appliances 158, 160, 162 may be configured to be worn over the user's eyes. The VR appliances 158, 160, 162 may comprise displays positioned to be viewed by the users 136, 138, 140. In some examples, VR appliances 158, 160, 162 may also comprise audio output devices such as speakers, headphones, ear buds, and/or the like. In some examples, a VR appliance 158, 160, 162 may completely block the user's eyes so that images provided by displays of the VR appliance are the only images perceived by the users 136, 138, 140. In other examples, a VR appliance 158, 160, 162 may partially obscure the user's vision and/or may not obscure the user's vision. For example, a rendering of the VR user interface 142, 144, 146 may be superimposed over a user's existing field-of-view, in an arrangement that may be referred to as augmented reality (AR) or extended reality (ER).

In some examples, VR appliances 158, 160, 162 are in direct communication with the VR host computing system 102 and may receive all or part of the VR user interfaces 142, 144, 146 directly from the VR host computing system 102. In other examples, the VR appliances 158, 160, 162 are in communication with respective user computing devices 130, 132, 134. The user computing devices 130, 132, 134 may receive the VR user interfaces 142, 144, 146 from the VR host computing system 102 and provide all or parts of the VR user interfaces 142, 144, 146 to the respective VR appliances 158, 160, 162 for display to the users 136, 138, 140.

In an augmented or extended reality environment, the user may physically travel to an augmented reality location associated with one or more of the systems 104, 106, 108. For example, the financial institution system 104 may be associated with various bank branches, which may be augmented reality locations. The merchant system 106 may be associated with various retail outlets, which may be augmented reality locations. The VR host computing system 102 may provide various user interface elements in the VR user interfaces 142, 144, 146 that are configured to be superimposed over the user's existing field-of-view to at least partially overlap the augmented reality location in the user's view. For example, if the user travels to an augmented reality location that is a bank branch, the VR host computing system 102 may provide user interface elements in the VR user interfaces 142, 144, 146 that highlight the bank branch, provide information about the bank branch, and/or the like.

In some examples, user computing devices 130, 132, 134 and/or VR appliances 158, 160, 162 execute an application that facilitates the provision of the VR user interfaces 142, 144, 146. In some examples, the application is a web browser that communicates with the VR host computing system 102 to receive and display the VR user interfaces 142, 144, 146. For example, the VR user interfaces 142, 144, 146 may be or include a web page displayed at the user computing device 130, 132, 134 via the web browser.

Users 136, 138, 140 may authenticate to the VR host computing system 102 by providing credential data. In some examples, users 136, 13A, 140 may authenticate directly to one or more of the financial institution system 104, the merchant system 106, the social media system 108, and/or the gaming system 110. Users 136, 138, 140 may provide credential data, for example, utilizing a virtual keyboard or other input device provided through the VR user interfaces 142, 144, 146. For example, the users 136, 138, 140 may provide a user name, a password, and/or other suitable credential data. In some examples, the user may provide authorization for the VR host computing system 102 or other system 104, 106, 108, 110 to access the user's credential data from an outside system such as, for example, a certificate authority and/or the like.

In some examples, the VR host computing system may authenticate a user 136, 138, 140 in response to the user visiting a site associated with one or more of the systems 104, 106, 108, 110. In a pure virtual environment, the user 136, 138, 140 may access a virtual site associated with, the one or more of the systems 104, 106, 108, 110.

In some examples, the VR host computing system 102, or other system 104, 106, 108, 110, may determine when the user 136, 138, 140 is within a threshold distance of an augmented reality location. When the user 136, 138, 140 moves within the threshold distance of an augmented reality location, it may trigger the VR host computing system 102 to authenticate the user 136, 138, 140.

The VR host computing system 102 may authenticate the user by checking the provided credential data with stored credential data for the user 136, 138, 140. The VR host computing system 102 may also compare the credential data to a credential data standard. In some examples, the VR host computing system 102 may provide the provided credential data to one or more of the associated systems 104, 106, 108, 110. The respective systems 104, 106, 108 110 may compare the provided credential data to credential data for the user stored by the respective systems 104, 106, 108, 110.

The credential data standard may describe a desired security characteristic or characteristics of the user's credential data. For example, the credential data standard may indicate that the user's credential data should have certain characteristics such as, for example, a minimum length, a minimum variety of alphanumeric characters, and/or the like. In some examples, the credential data standard may indicate that the user's credential data should be of a particular type such as, for example biometric credential data. In another example, the credential data standard may indicate that the user 136, 138, 140 should not use the same credential data for multiple accounts. For example, a user 136, 138, 140 may have accounts with more than one of the respective systems 104, 106, 108, 110. If the VR host computing system 102 determines that the user 136, 138, 140 is using the same credential data (or similar credential data) for more than one of the respective systems 104, 106, 108, 110, the credential data may not meet the credential data standard. For example, the VR host computing system 102 may receive stored credential data for the user 136, 138, 140 from one or more of the systems 104, 106, 108, 110. If the provided credential data differs from stored credential data of one or more of the other systems 104, 106, 108, 110 by less than a threshold difference, then the provided credential data may not meet the credential data standard. In some examples, the threshold distance may be a number of common characters, a percentage of common characters, and/or the like.

If a user's credential data fails to meet the credential data standard, the VR host computing system 102 may serve, via the VR user interface 142, 144, 146, one or more user interface elements the user's credential data indicating to the user that the user's credential data could be made more secure. Examples of such user interface elements are shown with the VR user interface 144.

A user interface element 150 includes alphanumeric characters describing a deficiency of the user's credential data relative to the credential data standard. For example, the user interface element 150 may include alphanumeric characters telling the user that their credential data is not strong. In some examples, the user interface element 150 may provide additional details, for example, indicating one or more reasons that the user's credential data failed to meet the credential data standard. The user interface element 150 may be positioned within the VR interface 144 in any suitable position. For example, the user interface element 150 may be positioned in space in front of the user, beside the user, and/or near an augmented reality location.

In some examples, the user interface element 150 may also include a suggestion for improving the security of the user's credential data. For example, the user interface element 150 may invite the user to select a new password, configure biometric credential data, set up multi-factor authentication, and/or otherwise improve the security of the user's credential data. In some examples, the user interface element 150 is a selectable by the user 138. When the user 138 selects the user interface element 150, the VR host computing system 102 may be programmed to implement an improvement to the security of the users credential data such as, for example, by setting up a new password for the user 138, implementing biometric credential data for the user 138, setting up multi-factor authentication for the user 138, and/or the like.

A user interface element 154 may comprise an animated element indicating a potential reduction to the user's account balance. For example, the user interface element 154 may initially comprise alphanumeric characters indicating the balance of a financial or other account associated with the user 138. In some examples, the indicated balance is not a balance of an actual account of the user 138 so as not to alarm the user 138 into believing that the user's account balance is actually decreasing. For example, the selected balance may be significantly higher or significantly lower than an actual balance of the user's account. In some examples, the selected balance may be one or more orders of magnitude higher and/or one or more orders of magnitude lower. The alphanumeric characters indicating the balance may be animated, for example, by changing the specific characters displayed, the indicated balance may decrease.

A user interface element 152 also comprises an animated element. The user interface element 152 may depict a thief or other malign actor escaping with stolen money or goods. For example, the user interface element 152 may depict a humanoid figure representing the thief or other malign actor. The humanoid figure may be carrying a bag or other container labeled with a dollar sign or other indicator of currency. In some examples, the depiction of the thief or other malign actor may be carrying another indicator of value. The user interface element 152 may be animated by manipulating the depiction of the thief or other malign actor to illustrate them moving away from the user, from an augmented reality location, and/or the like.

In some examples, so as to avoid unduly alarming the user 138, the user interface element 152 may be depicted in a manner that demonstrates that it is a representation and does not indicate a real theft of the property of the user 138. For example, the thief or other malign actor may be represented as a two-dimensional or cut out figure, as shown in FIG. 1. This may contrast with other elements in the virtual reality environment and/or in the user surroundings in an augmented reality arrangement. Also, in addition to or instead of depicting the thief or other malign actor in two spatial dimensions, the VR host computing system 102 may depict the thief or other malign actor in a cartoon manner. For example, the thief or other malign actor represented by the user interface element 152 may be depicted with exaggerated features.

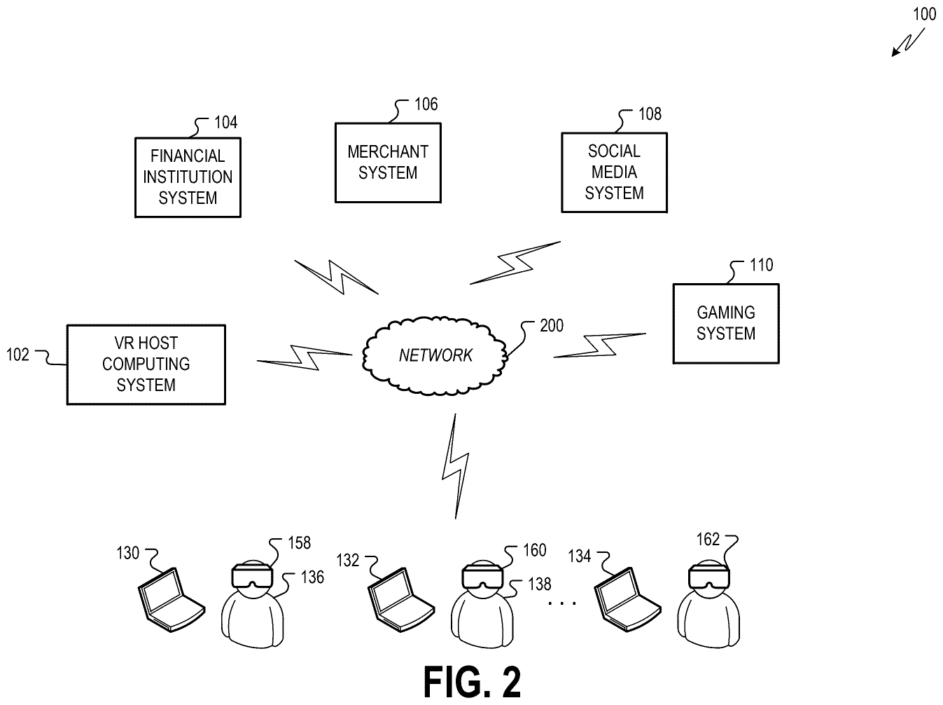

FIG. 2 is a diagram showing another example of the environment 100 including additional details. In the example of FIG. 2, the VR host computing system 102; user computing devices 130, 132, 134; VR appliances 158, 160, 162; and systems 104, 106, 108, 110 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, a combination of two or more such networks, and so forth.

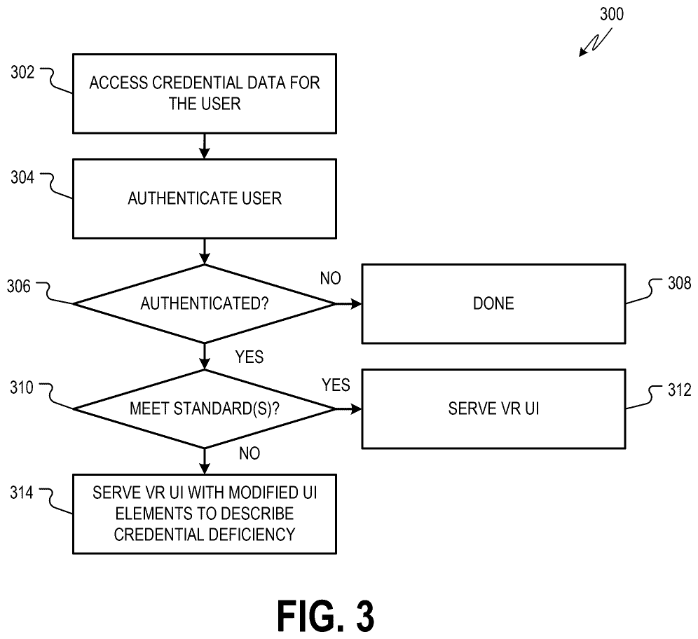

FIG. 3 is a flowchart showing one example of a process flow 300 that may be executed in the environment 100 to authenticate a user, such as one of the users 136, 138, 140 of FIG. 1. At operation 302, the VR host computing system 102 may access credential data for the user. The credential data may be provided by the user, for example, using a virtual keyboard or other input device at a VR user interface. In some examples, the accessed credential data is received by the VR host computing system 102 from a user computing device 130, 132, 134 or VR appliance 158, 160, 162.

At operation 304, the VR host computing system 102 may authenticate the user. This may include, for example, comparing the accessed credential data to stored credential data for the user. If the accessed credential data matches the stored credential data for the user, then the user is authenticated. At operation 306, the VR host computing system 102 may determine if the user was successfully authenticated at operation 304. If the user was not successfully authenticated at operation 304, then the process flow 300 may terminate at operation 308. In some examples, the VR host computing system 102 may provide the accessed credential data to one or more of the systems 104, 106, 108, 110. The respective system or systems 104, 106, 108, 110 may compare the accessed credential data to stored credential data and provide a response to the VR host computing system 102 indicating that the user is authenticated or not authenticated. Also, in some examples, the VR host computing system 102 may authenticate the user by providing for the user to directly provide the credential data to one or more of the respective systems 104, 106, 108, 110.

If the user is successfully authenticated at operation 304, then the VR host computing system 102 may determine, at operation 310, if the user's credential data meets a credential data standard. If the credential data meets the credential data standard, then the VR host computing system 102 may serve a virtual reality user interface to the user at operation 312. In some examples, serving the virtual reality user interface at operation 312 may include serving one or more user interface elements to a virtual reality user interface that is already being provided to the user. For example, if the user is authenticating with respect to a particular system 104, 106, 108, 110, the user may not be provided with a user interface element associated with the particular system 104, 106, 108, 110 until the user is authenticated to that system.

If the user's credential data fails to meet the credential data standard, then, the VR host computing system 102 may, at operation 314, serve the virtual reality interface to the user with one or more modified user interface elements that describe the deficiency in the user's credential data. This may include, as described herein, a first user interface element describing the deficiency of the users credential data and a second user interface element comprising an animated element illustrating a potential consequence of a breach of the users credential data.

In some examples, the VR host computing system 102 may provide to the user computing device 130, 132, 134 and/or VR appliance 158, 160, 162 and indication that the user's credential data fails to meet the credential data standard. The user computing device 130, 132, 134 and/or VR appliance 158, 160, 162 may display the served virtual reality interface and user interface elements in response to accessing the indication that the user's credential data fails to meet the credential data standard.

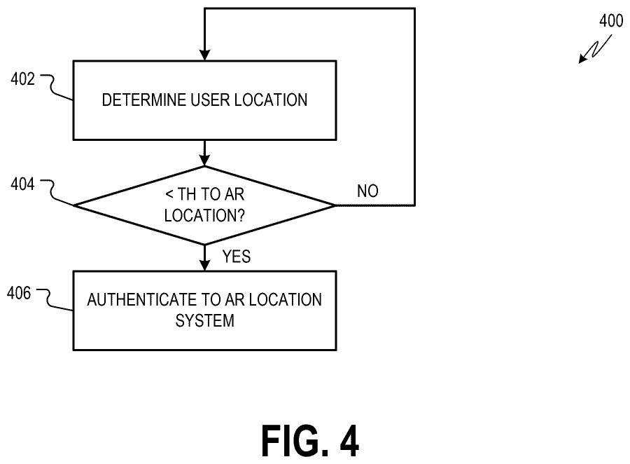

FIG. 4 is a flowchart showing one example of a process flow 400 that may be executed by the VR host computing system 102 to determine to authenticate a user in an augmented or extended reality environment. In the augmented or extended reality environment, the user is authenticated when the user is within a threshold distance of an augmented reality location. At operation 402, the VR host computing system 102 may determine a geographic location of the user. This may include, for example, communicating with a user computing device and/or VR appliance of the user to receive the location of the user, which may be determined by a GPS or other suitable sensor at the user computing device and/or VR appliance.

At operation 404, the VR host computing system 102 may determine whether the user's location is within a threshold distance of an augmented reality location. If the user's location is not within the threshold distance of an augmented reality location, then the process may continue at operation 402. For example, the user may move, causing the user to become closer to an augmented reality location.

If the user's location is within the threshold distance of the augmented reality location at operation 404, then the VR host computing system 102 may authenticate the user. For example, the VR host computing system 102 may authenticate the user as described herein with respect to FIG. 3 and the process flow 300. In some examples, operation 406 may be performed by a user computing device and/or VR appliance. For example, at operation 406, the user computing device and/or VR appliance may request authentication from the VR host computing system 102. In response to the request, the VR host computing system 102 may authenticate the user, for example, as described herein with respect to FIG. 3 and the process flow 300.

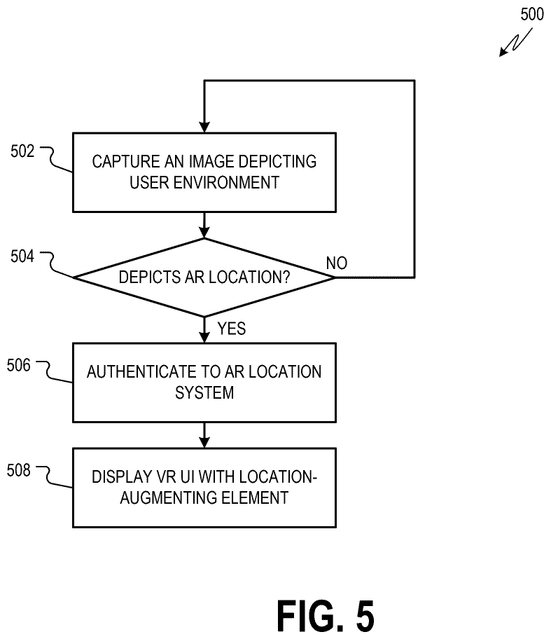

FIG. 5 is a flowchart showing another example of a process flow 500 that may be executed by the VR host computing system 102 to determine to authenticate a user in an augmented or extended reality environment. In this example, the user is authenticated when the user's virtual reality appliance and/or user computing device captures an image depicting an augmented reality location.

At operation 502, a user computing device and/or VR appliance of the user captures an image depicting the user's environment. The image may be captured with a camera or other suitable image sensor of the user computing device and/or VR appliance. At operation 504, the user computing device and/or VR appliance may determine whether the captured image depicts an augmented reality location. If the captured image does not depict an augmented reality location, then the process may continue at operation 502. For example, the user may move to different locations and/or pivot to different vantage points such that a subsequently captured image may depict an augmented reality location.

If the captured image does depict an augmented reality location, then the VR host computing system 102 may authenticate the user at operation 506, for example, as described herein with respect to FIG. 3 and the process flow 300. For example, the user computing device and/or VR appliance of the user may request authentication from the VR host computing system 102 upon determining that the captured image indicates an augmented reality location. Also, in some examples, the user computing device and/or VR appliance may provide some or all of the captured image to the VR host computing system 102, which may perform the operation 504 by analyzing the captured image to determine whether it depicts an augmented reality location.

At operation 508, the user computing device and/or VR appliance may display the VR user interface to the user in a manner that includes at least one location augmenting user interface element. In some examples, the VR user interface, including the user interface elements thereof, may be served to the user computing device and/or VR appliance by the VR host computing system 102.

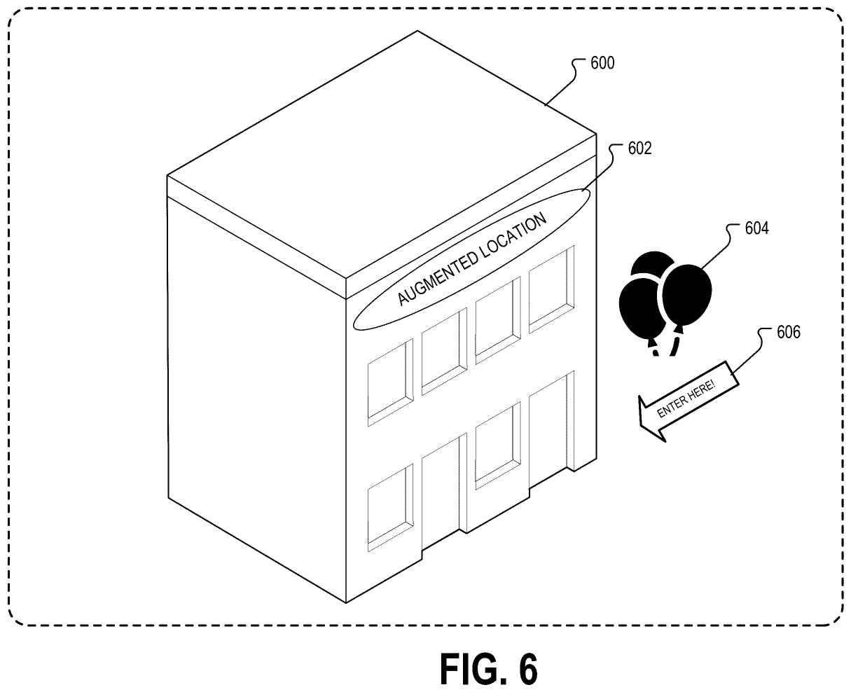

FIG. 6 is a diagram showing one example of augmented user interface elements in a VR user interface. In FIG. 6, an augmented reality location comprises a building 600. It will be appreciated that, in various examples, augmented reality locations may include other geographic location such as, for example, tens, parks, and/or the like. In the example of FIG. 6, the VR user interface provides augmented user interface elements 602, 604, 606. The augmented user interface element 602 depicts a sign that is positioned on the building 600. The sign may include alphanumeric characters describing the augmented reality location. The augmented user interface element 604 comprises balloons. The balloons may be intended to draw the user's attention to the augmented reality location. It will be appreciated that other example augmented user interface elements to draw attention to the augmented reality location may be used such as, for example, flags, banners, fireworks, and/or the like. The augmented user interface element 606 directs the user to an entrance of the building 600.

The augmented user interface elements 602, 604, 606 may be superimposed over the user's existing field-of-view. For example, the building 600 may be visible to the user without the assistance of the users VR appliance. The VR appliance, when displaying the user interface, may superimpose the augmented user interface elements over the user's existing field-of-view such that the user sees the building 600 that is physically present and the augmented user interface elements 602, 604, 606, as illustrated in FIG. 6.

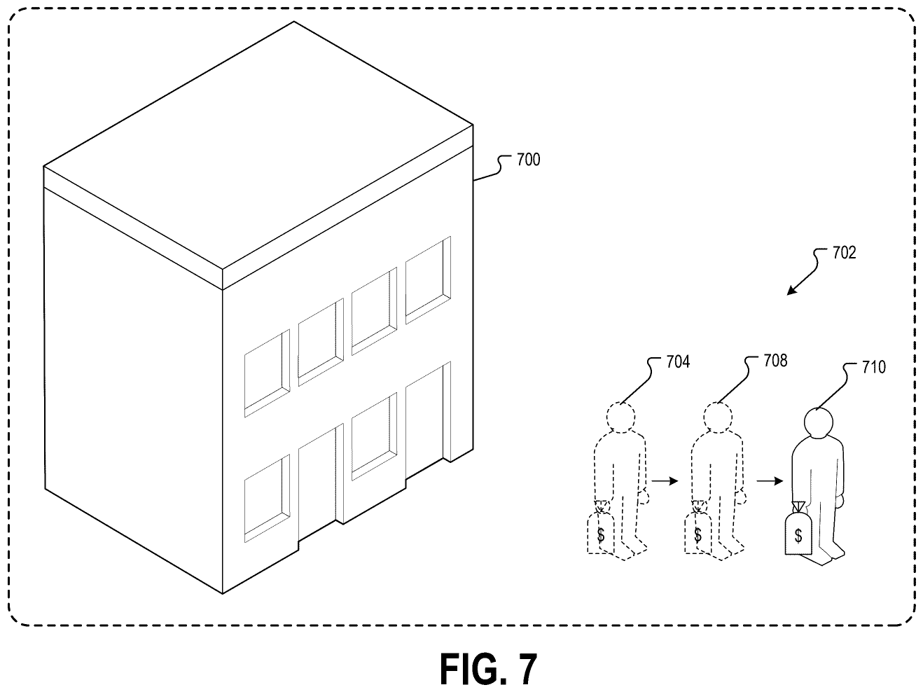

FIG. 7 is a diagram showing one example of augmented user interface elements in a VR user interface, including a user interface element with an animated element 702 illustrating a potential consequence of a breach of the user's credential data. In this example, the animated element 702 depicts a thief or other malign actor absconding with an item of value, in this case a bag with a dollar sign indicating money. The VR host computing system 102 may serve the animated element 702 in different positions at different times so as to cause the figure to appear to move across the user's field-of-view. For example, at a first time, the animated element 702 may be at a position 704. At a second time subsequent to the first time, the animated element 702 may be at a position 708. At a third time, the animated element 702 may be at a position 710. In this way, the animated element may appear to be running away from the building 700. The building 700 may be a real bricks and mortar building in an augmented reality environment and/or may be a virtual building in a pure virtual environment.

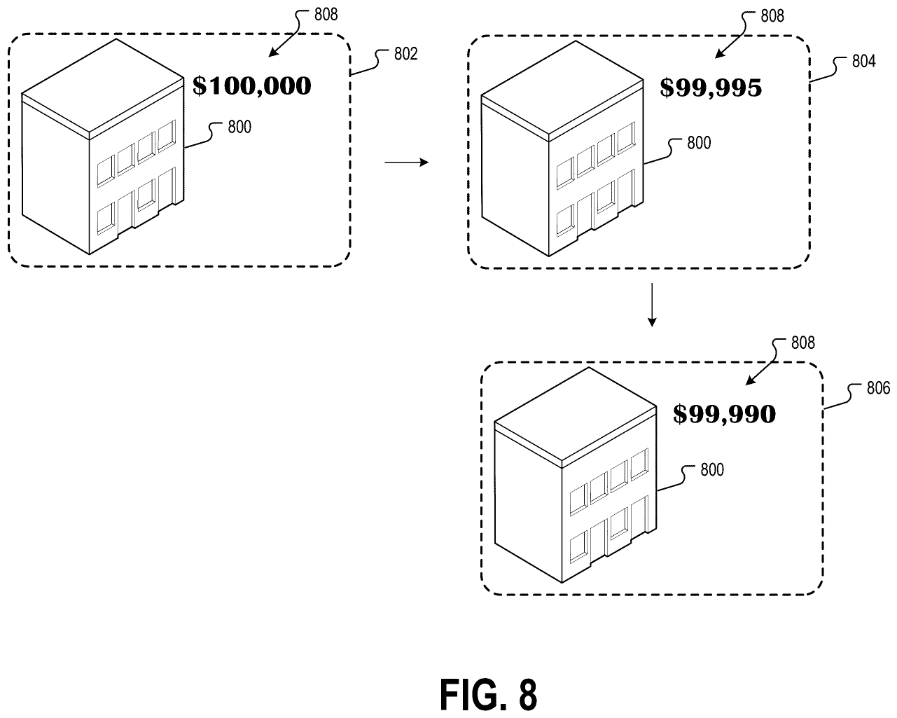

FIG. 8 is a diagram showing one example of augmented user interface elements in a VR user interface, including a user interface element with an animated element 808 illustrating a potential consequence of a breach of the user's credential data. In this example, the animated element 808 depicts an account balance in alphanumeric characters. As time moves forward, the value of the account balance decreases. FIG. 8 shows three instances 802, 804, 806 of the VR user interface showing the animated element 808 at different points in time. The instances 804 may be displayed after the instances 802. Similarly, the instances 806 may be shown after the instance 804.

In this example, the instances 802, 804, 806 of the VR user interface also show an example augmented location, in this example, a building 800. This demonstrates that, in some examples, the animated element 808 may be an augmented user interface element positioned near an augmented location, as shown. In other examples, the animated element 808 may be displayed in a non-augmented virtual reality environment.

At instance 802, the animated element 808 displays alphanumeric characters indicating a balance of $100,000. At instance 804, the animated element 808 displays alphanumeric characters indicating a balance less than $100,000, in this example, $99,995. At instance 806, the animated element 808 displays alphanumeric characters indicating a balance less than $99,905, in this example $99,990. Successively displaying the values of the animated element 808 at instances 802, 804, 806 of the VR user interface may create an appearance to a user that the display balance is being reduced. In some examples, this may create an impression of a reduced account balance that may be associated with a breach of the user's credential data.

Although the example of FIG. 8 shows the value of the animated element 808 being reduced in increments of five dollars, it will be appreciated that any suitable increment may be used. Also, in some examples, the initial value of the animated element 808 may be selected so as to avoid confusion with an actual account balance of the user. For example, if the initial value of the animated element 808 is too close to the balance of an account held by the user, the user may mistakenly interpret the animated element 808 as an indication that the user's own account balance is being reduced.

In some examples, the initial value of the animated element 808 is chosen to be one or more orders of magnitude larger than the highest balance of an account held by the user, for example, at a financial institution implementing the VR host computing system or associated with the enterprise implementing the VR host computing system. In another example, the initial value of the animated element 808 is chosen to be one or more orders of magnitude smaller than the highest balance of an account held by the user. In still other examples, the initial value of the animated element 808 may be a round value that is unlikely to be an actual account balance. Consider the example of FIG. 8, where the initial value of the animated element 808 is exactly $100,000. In some examples, the increment at which the balance displayed by the animated element 808 is reduced may also be selected to be a round number, such as, for example, five dollars, $10, $100, $1000, $10,000, $100,000, and/or the like. This may indicate to the user that the account balance reductions displayed by the animated element 808 do not represent an actual reduction in the users balance. Also, although the example of FIG. 8 shows account balances in dollars, it will be appreciated that any other suitable currency may be used.

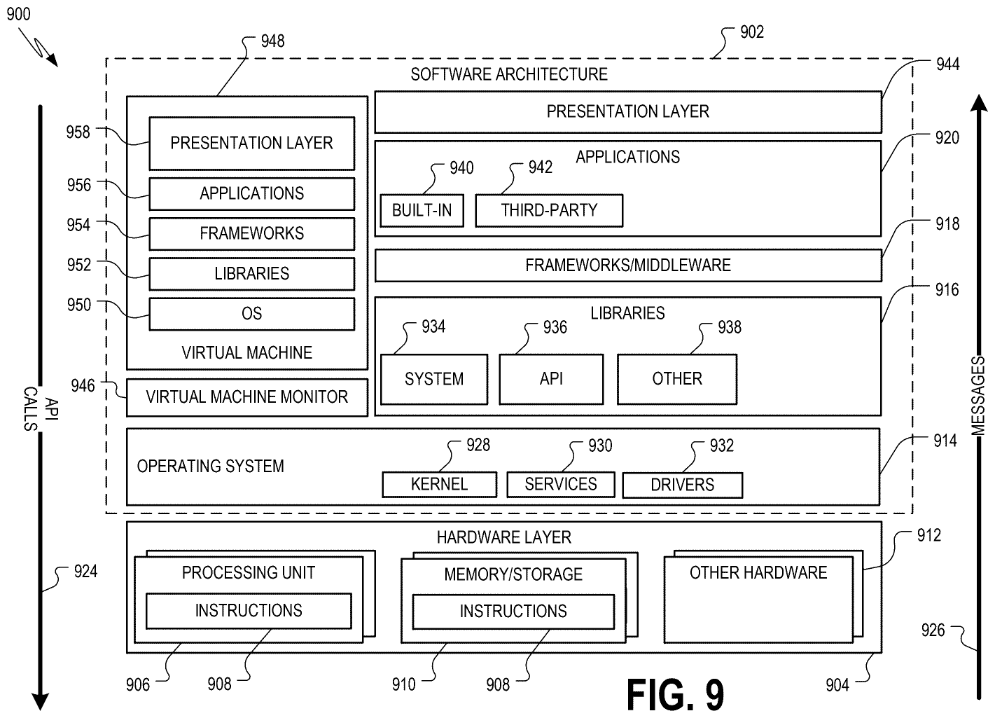

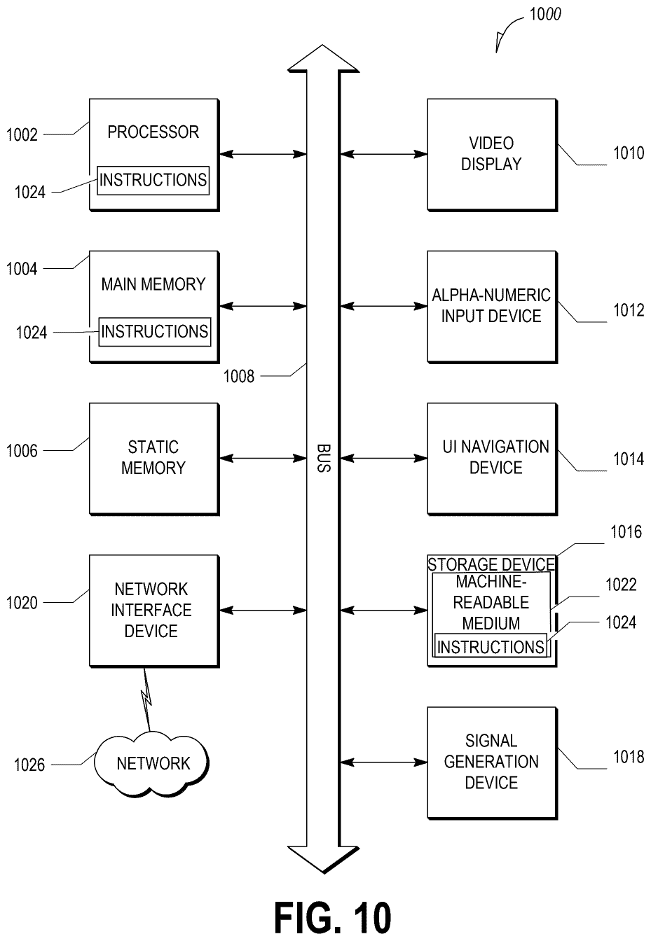

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture 902, and many other architectures may be implemented to facilitate the functionality described herein. A representative hardware layer 904 is illustrated and can represent, for example, any of the above-referenced computing devices. In some examples, the hardware layer 904 may be implemented according to an architecture 1000 of FIG. 10.

The representative hardware layer 904 comprises one or more processing units 906 having associated executable instructions 908. The executable instructions 908 represent the executable instructions of the software architecture 902, including implementation of the methods, modules, components, and so forth of FIGS. 1-10. The hardware layer 904 also includes memory and/or storage modules 910, which also have the executable instructions 908. The hardware layer 904 may also comprise other hardware 912, which represents any other hardware of the hardware layer 904, such as the other hardware illustrated as part of the architecture 1000.

In the example architecture of FIG. 9, the software architecture 902 may be conceptualized as a stack of layers where each layer provides particular functionality. For example, the software architecture 902 may include layers such as an operating system 914, libraries 916, middleware layer 918, applications 920, and a presentation layer 944. Operationally, the applications 920 and/or other components within the layers may invoke application programming interface (API) calls 924 through the software stack and receive a response, returned values, and so forth illustrated as messages 926 in response to the API calls 924. The layers illustrated are representative in nature and not all software architectures have all layers. For example, some mobile or special-purpose operating systems may not provide a middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of a hardware or software interrupt and, in response, cause the software architecture 902 to pause its current processing and execute an ISR when an interrupt is received. The ISR may generate an alert.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than by interfacing directly with the underlying operating system 914 functionality (e.g., kernel 928, services 930, and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The middleware layer 918 (also sometimes referred to as frameworks) may provide a higher-level common infrastructure that may be utilized by the applications 920 and/or other software components/modules. For example, the middleware layer 918 may provide various graphical UI functions, high-level resource management, high-level location services, and so forth. The middleware layer 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. The third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 942 may invoke the API calls 924 provided by the mobile operating system such as the operating system 914 to facilitate functionality described herein.

The applications 920 may utilize built-in operating system functions (e.g., kernel 928, services 930, and/or drivers 932), libraries (e.g., system libraries 934, API libraries 936, and other libraries 938), or middleware layer 918 to create UIs to interact with users of the system. Alternatively, or additionally, in some systems, interactions with a user may occur through a presentation layer, such as the presentation layer 944. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 9, this is illustrated by a virtual machine 948. A virtual machine creates a software environment where applications/modules can execute as if they were executing on a hardware computing device. The virtual machine 948 is hosted by a host operating system (e.g., the operating system 914) and typically, although not always, has a virtual machine monitor 946, which manages the operation of the virtual machine 948 as well as the interface with the host operating system (e.g., the operating system 914). A software architecture executes within the virtual machine 948, such as an operating system 950, libraries 952, frameworks/middleware 954, applications 956, and/or a presentation layer 958. These layers of software architecture executing within the virtual machine 948 can be the same as corresponding layers previously described or may be different.

FIG. 10 is a block diagram illustrating a computing device hardware architecture 1000, within which a set or sequence of instructions can be executed to cause a machine to perform examples of any one of the methodologies discussed herein. The architecture 1000 may describe, for example, any of the computing devices and/or control circuits described herein. The architecture 1000 may execute the software architecture 902 described with respect to FIG. 9. The architecture 1000 may operate as a standalone device or may be connected (e.g., networked) to other machines. In a networked deployment, the architecture 1000 may operate in the capacity of either a server or a client machine in server-client network environments, or it may act as a peer machine in peer-to-peer (or distributed) network environments. The architecture 1000 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1000 includes a processor unit 1002 comprising at least one processor (e.g., a central processing unit (CPU), a graphics processing unit (GPU), or both, processor cores, compute nodes, etc.). The architecture 1000 may further comprise a main memory 1004 and a static memory 1006, which communicate with each other via a link 1008 (e.g., a bus). The architecture 1000 can further include a video display unit 1010, an alphanumeric input device 1012 (e.g., a keyboard), and a UI navigation device 1014 (e.g., a mouse). In some examples, the video display unit 1010, alphanumeric input device 1012, and UI navigation device 1014 are incorporated into a touchscreen display. The architecture 1000 may additionally include a storage device 1016 (e.g., a drive unit), a signal generation device 1018 (e.g., a speaker), a network interface device 1020, and one or more sensors (not shown), such as a GPS sensor, compass, accelerometer, or other sensor.

In some examples, the processor unit 1002 or another suitable hardware component may support a hardware interrupt. In response to a hardware interrupt, the processor unit 1002 may pause its processing and execute an ISR, for example, as described herein.

The storage device 1016 includes a non-transitory machine-readable medium 1022 on which is stored one or more sets of data structures and instructions 1024 (e.g., software) embodying or utilized by any one or more of the methodologies or functions described herein. The instructions 1024 can also reside, completely or at least partially, within the main memory 1004, within the static memory 1006, and/or within the processor unit 1002 during execution thereof by the architecture 1000, with the main memory 1004, the static memory 1006, and the processor unit 1002 also constituting machine-readable media. The instructions 1024 stored at the machine-readable medium 1022 may include, for example, instructions for implementing the software architecture 902, instructions for executing any of the features described herein, etc.

While the machine-readable medium 1022 is illustrated in an example to be a single medium, the term “machine-readable medium” can include a single medium or multiple media (e.g., a centralized or distributed database, and/or associated caches and servers) that store the one or more instructions 1024. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1024 can further be transmitted or received over a communications network 1026 using a transmission medium via the network interface device 1020 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 7G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 77 C.F.R. § 1.72 (b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A virtual reality (VR) appliance for authenticating a user to a VR host computing system, the VR appliance comprising:
at least one processor programmed to perform operations comprising:
accessing credential data for the user;
accessing an indication that the credential data fails to meet a credential data standard;
authenticating the user to the VR host computing system using the credential data;
serving, to the user, a VR user interface; and
responsive to the indication that the credential data fails to meet the credential data standard, modifying the VR user interface to include a first user interface element and a second user interface element, the first user interface element describing a deficiency of the credential data, and the second user interface element comprising at least one animated element illustrating a potential consequence of a breach of the credential data for the user.

2. The VR appliance of claim 1, the operations further comprising determining that a location of the user is within a threshold distance of a location of an augmented reality location associated with the VR host computing system, the accessing of the credential data being responsive to the determining that the location of the user is within the threshold distance of the location of the augmented reality location.

3. The VR appliance of claim 1, the operations further comprising:
capturing image data depicting a portion of an environment around the user;
determining that the image data depicts an augmented reality location associated with the VR host computing system, the accessing of the credential data being responsive to the determining that the image data depicts an augmented reality location; and
modifying the VR user interface to display an augmented interface element to the user, the augmented interface element being presented
using an augmented reality display of the VR appliance, display an augmented interface element to the user while permitting an environment of the user to be viewed through the augmented reality display, the augmented interface element being positioned in the augmented reality display to at least partially overlap the augmented reality location.

4. The VR appliance of claim 1, the user having a plurality of accounts accessible to the VR host computing system, the plurality of accounts comprising a first account associated with the credential data and a second account associated with second credential data, the operations further comprising determining that a difference between the credential data and the second credential data is less than a threshold difference, the indication that the credential data fails to meet at least one credential data standard being based at least in part on the determining that a difference between the credential data and the second credential data is less than the threshold difference.

5. The VR appliance of claim 1, the first user interface element comprising alphanumeric characters describing the deficiency of the credential data.

6. The VR appliance of claim 1, the at least one animated element comprising alphanumeric characters indicating a financial account balance, the serving of at least one animated element comprising modifying the alphanumeric characters indicating the financial account balance to reduce the indicated financial account balance.

7. The VR appliance of claim 1, the at least one animated element comprising a depiction of a humanoid figure with a container moving away from the user.

8. The VR appliance of claim 1, the at least one animated element being depicted at the VR user interface in two dimensions, and at least one other element being depicted at the VR user interface in three dimensions.

9. A method of authenticating a user to a virtual reality (VR) host computing system, the method comprising:
accessing, by a VR appliance, credential data for the user;
accessing, by the VR appliance, an indication that the credential data fails to meet a credential data standard;
authenticating the user to the VR host computing system, by the VR appliance, using the credential data;
serving, by the VR appliance and to the user, a VR user interface; and
responsive to the indication that the credential data fails to meet the credential data standard, modifying the VR user interface to include a first user interface element and a second user interface element, the first user interface element describing a deficiency of the credential data, and the second user interface element comprising at least one animated element illustrating a potential consequence of a breach of the credential data for the user.

10. The method of claim 9, further comprising determining, by the VR appliance, that a location of the user is within a threshold distance of a location of an augmented reality location associated with the VR host computing system, the accessing of the credential data being responsive to the determining that the location of the user is within the threshold distance of the location of the augmented reality location.

11. The method of claim 9, further comprising:
capturing, by the VR appliance, image data depicting a portion of an environment around the user;
determining, by the VR appliance, that the image data depicts an augmented reality location associated with the VR host computing system, the accessing of the credential data being responsive to the determining that the image data depicts an augmented reality location; and
using an augmented reality display of the VR appliance, display an augmented interface element to the user while permitting an environment of the user to be viewed through the augmented reality display, the augmented interface element being positioned in the augmented reality display to at least partially overlap the augmented reality location.

12. The method of claim 9, the user having a plurality of accounts accessible to the VR host computing system, the plurality of accounts comprising a first account associated with the credential data and a second account associated with second credential data, the method further comprising determining that a difference between the credential data and the second credential data is less than a threshold difference, the indication that the credential data fails to meet at least one credential data standard being based at least in part on the determining that a difference between the credential data and the second credential data is less than the threshold difference.

13. The method of claim 9, the first user interface element comprising alphanumeric characters describing the deficiency of the credential data.

14. The method of claim 9, the at least one animated element comprising alphanumeric characters indicating a financial account balance, the serving of at least one animated element comprising modifying the alphanumeric characters indicating the financial account balance to reduce the indicated financial account balance.

15. The method of claim 9, the at least one animated element comprising a depiction of a humanoid figure with a container moving away from the user.

16. The method of claim 9, the at least one animated element being depicted at the VR user interface in two dimensions, and at least one other element being depicted at the VR user interface in three dimensions.

17. A non-transitory machine-readable medium comprising instructions thereon that, when executed by at least one processor, because the at least one processor to perform operations comprising:
accessing credential data for a user;
accessing an indication that the credential data fails to meet a credential data standard;
authenticating the user to a VR host computing system using the credential data;
serving, to the user, a VR user interface; and
responsive to the indication that the credential data fails to meet the credential data standard, modifying the VR user interface to include a first user interface element and a second user interface element, the first user interface element describing a deficiency of the credential data, and the second user interface element comprising at least one animated element illustrating a potential consequence of a breach of the credential data for the user.

18. The non-transitory machine-readable medium of claim 17, the operations further comprising determining that a location of the user is within a threshold distance of a location of an augmented reality location associated with the VR host computing system, the accessing of the credential data being responsive to the determining that the location of the user is within the threshold distance of the location of the augmented reality location.

19. The non-transitory machine-readable medium of claim 17, the operations further comprising:
capturing image data depicting a portion of an environment around the user;
determining that the image data depicts an augmented reality location associated with the VR host computing system, the accessing of the credential data being responsive to the determining that the image data depicts an augmented reality location; and
using an augmented reality display of the VR appliance, display an augmented interface element to the user while permitting an environment of the user to be viewed through the augmented reality display, the augmented interface element being positioned in the augmented reality display to at least partially overlap the augmented reality location.

20. The non-transitory machine-readable medium of claim 17, the user having a plurality of accounts accessible to the VR host computing system, the plurality of accounts comprising a first account associated with the credential data and a second account associated with second credential data, the operations further comprising determining that a difference between the credential data and the second credential data is less than a threshold difference, the indication that the credential data fails to meet at least one credential data standard being based at least in part on the determining that a difference between the credential data and the second credential data is less than the threshold difference.
